(19) United States
(12) Patent Application Publication
(10) Pub. No.: US 2005/0224419 A1
(43) Pub. Date: Oct. 13, 2005

(54) Use of derivatized nanoparticles to minimize growth of micro-organisms in hot filled drinks

(75) Inventors: Richard W. Wien, Pittsford, NY (US); David L. Patton, Webster, NY (US); Joseph F. Bringley, Rochester, NY (US); Yannick J.F. Lerat, Mellecey (FR); William J. Harrison, Pittsford, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 11/037,319

(22) Filed: Jan. 18, 2005

Related U.S. Application Data
(63) Continuation-in-part of application No. 10/936,915, filed on Sep. 9, 2004.
Application No. 10/936,915 is a continuation-in-part of application No. 10/823,443, filed on Apr. 13, 2004.

(51) Int. Cl. B01D 15/00

(52) U.S. Cl. 210/681

(57) ABSTRACT

A method of removing a selected two or more different metal-ion sequestering agents for removing one or more designated metal ions. The method includes subjecting a liquid to a first metal-ion sequestering agent for removing a first designated metal ion prior to placing the liquid in a container; providing the container for holding the liquid, the container having an internal surface having a second metal-ion sequestering agent provided on at least a portion of the internal surface for removing a second designated metal-ion from the liquid; filling the container with the liquid in an open environment; and closing the container with the liquid contained therein.

### CROSS REFERENCE TO RELATED APPLICATIONS

This is a continuation-in-part application of U.S. patent application Ser. No. 10/936,915 filed Sep. 9, 2004 which is a continuation-in-part application of U.S. patent application Ser. No. 10/823,443, filed Apr. 13, 2004.

Reference is also made to commonly assigned co-pending U.S. patent application Ser. No. 10/823,453 filed Apr. 13, 2004 entitled ARTICLE FOR INHIBITING MICROBIAL GROWTH by Joseph F. Bringley, David L. Patton, Richard W. Wien, Yannick J. F. Lerat (docket 87834), U.S. patent application Ser. No. 10/823,446 filed Apr. 13, 2004 entitled CONTAINER FOR INHIBITING MICROBIAL GROWTH IN LIQUID NUTRIENTS by David L. Patton, Joseph F. Bringley, Richard W. Wien, John M. Pochan, Yannick J. F. Lerat (docket 87472); U.S. patent application Ser. No. 10/822,945 filed Apr. 13, 2004 entitled ARTICLE FOR INHIBITING MICROBIAL GROWTH IN PHYSIOLOGICAL FLUIDS by Joseph F. Bringley, David L. Patton, Richard W. Wien, Yannick J. F. Lerat (docket 87833); U.S. patent application Ser. No. 10/822,940, filed Apr. 13, 2004 entitled DERIVATIZED NANOPARTICLES COMPRISING METAL-ION SEQUESTRAINT by Joseph F. Bringley (docket 87428); and U.S. patent application Ser. No. 10/822,929 filed Apr. 13, 2004 entitled COMPOSITION OF MATTER COMPRISING POLYMER AND DERIVATIZED NANOPARTICLES by Joseph F. Bringley, Richard W. Wien, Richard L. Parton (docket 87708), U.S. patent application Ser. No. 10/822,939 filed Apr. 13, 2004 entitled COMPOSITION COMPRISING INTERCALATED METAL-ION SEQUESTRANTS by Joseph F. Bringley, David L. Patton, Richard W. Wien (docket 87765) the disclosures of which are incorporated herein by reference.

### FIELD OF THE INVENTION

The present invention relates to using metal-ion sequestering agents in a container filling process for removing bio-essential designated metal-ions from a liquid nutrient for inhibiting growth of microbes in the liquid nutrient.

### BACKGROUND OF THE INVENTION

During the process of filling containers with certain beverages and foodstuffs, air borne micro-organisms may enter the containers after the flash pasteurization or pasteurization part of the process. These micro-organisms such as yeast, spores, bacteria, etc. will grow in the nutrient rich beverage or food, ruining the taste or even causing hazardous micro-biological contamination. While some beverages are packaged by aseptic means or by utilizing preservatives, many other beverages for example fruit juices, teas and isotonic drinks are “hot-filled”. “Hot-filling” involves the filling of a container with a liquid beverage having some elevated temperature (typically, at about 180-200° F.). The container is capped and allowed to cool, producing a vacuum therein. The process of hot filling of beverages and foods is used to kill micro-organisms that enter the container during the filling of the beverage or food containers. Hot filling requires containers be made of certain materials or constructed in a certain fashion such as thicker walls to withstand the hot filling process. The energy required for hot filling adds to the cost of the filling process. Temperatures required for hot filling have a detrimental effect on the flavor of the beverage. Other methods of filling, such as aseptic filling, require large capital expenditures and maintenance of class 5 clean room conditions.

It has been recognized that small concentrations of metal-ions play an important role in biological processes. For example, Mn, Mg, Fe, Ca, Zn, Cu and Al are essential bio-metals, and are required for most, if not all, living systems. Metal-ions play a crucial role in oxygen transport in living systems, and regulate the function of genes and replication in many cellular systems. Calcium is an important structural element in the formation of bones and other hard tissues. Mn, Mg, Cu and Fe are involved in metabolism and enzymatic processes. At high concentrations, metals may become toxic to living systems and the organism may experience disease or illness if the level cannot be controlled. As a result, the availability, and concentrations, of metal-ions in biological environments is a major factor in determining the abundance, growth-rate and health of plant, animal and micro-organism populations. It has been recognized that iron is an essential biological element, and that all living organisms require iron for survival and replication. Although, the occurrence and concentration of iron is relatively high on the earth's surface, the availability of “free” iron is severely limited by the extreme insolubility of iron in aqueous environments. As a result, many organisms have developed complex methods of procuring “free” iron for survival and replication.

Methods for packaging drinks and liquid foodstuffs are needed that are able to improve food quality, to increase shelf-life, to protect from microbial contamination, and to do so in a manner that is safe and environmentally clean. Methods are needed that are able to target and remove specific, biologically important, metal-ions while leaving intact the concentrations of beneficial metal-ions.

### PROBLEM TO BE SOLVED BY THE INVENTION

“Hot filling” provides various advantages over aseptic or preservative packaging, among them lower capital and operational cost (over aseptic systems), and the elimination of the need for preservatives (the heat of the beverage has a sanitizing effect). The hot headspace in the filled bottle also reduces the carrying capacity of oxygen therein, limiting oxidation of the contents. There is however a problem in the hot filling of beverages and foods when used to kill air borne micro-organisms, that enter the containers during the filling process after the flash pasteurization or pasteurization of the beverage or food. Hot filling requires containers be made of certain materials or constructed in a certain fashion such as the use of thicker walls, more material and specific shapes to withstand the hot filling process. The energy required for hot filling adds to the cost of the filling process. Temperatures required for hot filling have a detrimental effect on the flavor of the beverage. Hot filling adds additional time to the manufacturing process in both the heating and cooling of the containers. The manufacturers of the beverages and foodstuffs are loathe to add antimicrobial materials directly to the beverages and foods because these may potentially alter the color or taste of items such as beverages and foodstuffs, and in the worst case may be harmful to the persons using or consuming those items. The wide spread use of antimicrobial materials may cause further problems in that disposal of the items containing these materials cannot be accomplished without impacting the biological health of the landfill or other site of disposal; and further the antimicrobial compounds may leach into surrounding rivers, lakes and water supplies. The wide spread use of antimicrobial materials may cause yet further problems in that micro-organisms may develop resistance to these materials and new infectious microbes and new diseases may develop.

Depending on the metal ion being removed or sequestered, the concentration of the metal ion must be lowered to ppb, while in other cases lowering the level to ppm is just as effective. The same is true for the amount or concentration of metal ion present at the start. In some cases the amount or concentration of metal ion initially present may be high. Both situations may require different methods of ion sequestering or removal. What is needed is a method of and system for handling both cases, that is handling a variety of initial different metal ion concentrations and removing metal ions to specific levels.

### SUMMARY OF THE INVENTION

In accordance with one aspect of the present invention, there is provided a method of removing a selected metal-ion from a solution, comprising the steps of:

a. subjecting a liquid to a first metal-ion sequestering agent for removing a first designated metal ion prior to placing the liquid in a container;

b. providing the container for holding the liquid, the container having an internal surface having a second metal-ion sequestering agent provided on at least a portion of the internal surface for removing a second designated metal-ion from the liquid;

c. filling the container with the liquid in an open environment; and

d. closing the container with the liquid contained therein.

In accordance with another aspect of the present invention there is provided a method of removing a selected two or more different metal-ions from a solution, comprising the steps of:

a. subjecting a liquid to a first metal-ion sequestering agent for removing a first designated metal ion prior to placing the liquid in a container;

b. providing the container for holding the liquid, the container having an internal surface having a second metal-ion sequestering agent provided on at least a portion of the internal surface for removing a second designated metal-ion from the liquid, the second designated metal ion being different from the first designated metal ion;

c. filling the container with the liquid in an open environment; and

d. closing the container with the liquid contained therein.

These and other aspects, objects, features and advantages of the present invention will be more clearly understood and appreciated from a review of the following detailed description of the preferred embodiments and appended claims and by reference to the accompanying drawings.

### BRIEF DESCRIPTION OF THE DRAWINGS

In the detailed description of the preferred embodiments of the invention presented below, reference is made to the accompanying drawings in which:

FIG. 1 is a schematic of a hot fill bottling process made in accordance with the prior art;

FIG. 2 illustrates a cross section of a fluid container made in accordance with the prior art;

FIG. 3 is an enlarged partial cross sectional view of a portion of the container of FIG. 2;

FIG. 4 is a view similar to FIG. 3 illustrating a container made in accordance with the present invention;

FIG. 5 illustrates a modified bottle and cap assembly also made in accordance with the present invention;

FIG. 6 is a schematic top plan view of the bottle and cap of FIG. 5;

FIG. 7 is an enlarged partial cross sectional view of the bottle and cap taken along line 7-7 of FIG. 6;

FIG. 8 is a schematic view of another embodiment of the present invention illustrating one method for applying a coating to the interior surface of a bottle made in accordance with the present invention;

FIG. 9 is an enlarged partial cross sectional view of a portion of the bottle of FIG. 8 illustrating the sprayed coating of the metal-ion sequestering agent;

FIG. 10 is a schematic of a hot fill bottling process made in accordance with the present invention;

FIG. 11 is a cross sectional view of a filter assembly made in accordance with the present invention;

FIG. 12 is a cross sectional view of a fluid bed ion exchange assembly made in accordance with the present invention;

FIG. 13 is an enlarged partial view of a portion of the fluid bed ion exchange assembly of FIG. 12 as identified by circle 22 illustrating a metal-ion sequestering agent; and

FIG. 14 is a schematic of a hot fill bottling process made in accordance with the present invention.

### DETAILED DESCRIPTION OF THE INVENTION

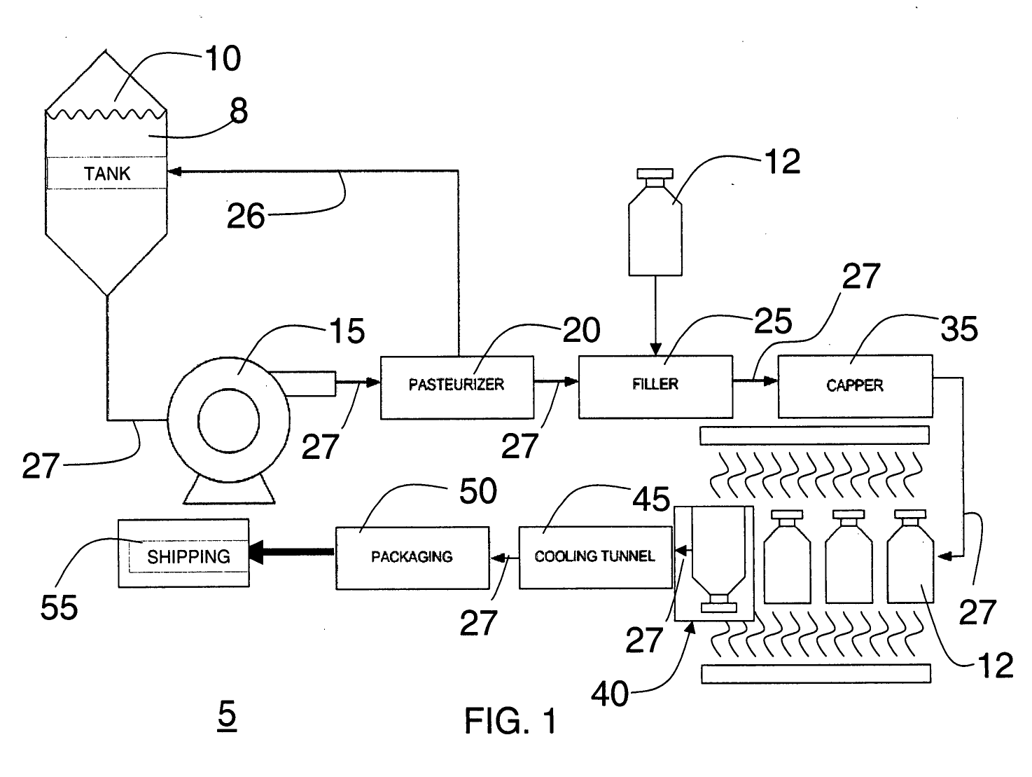

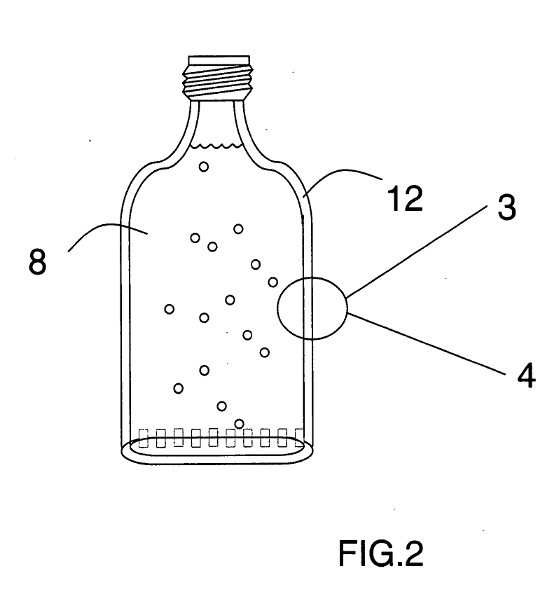

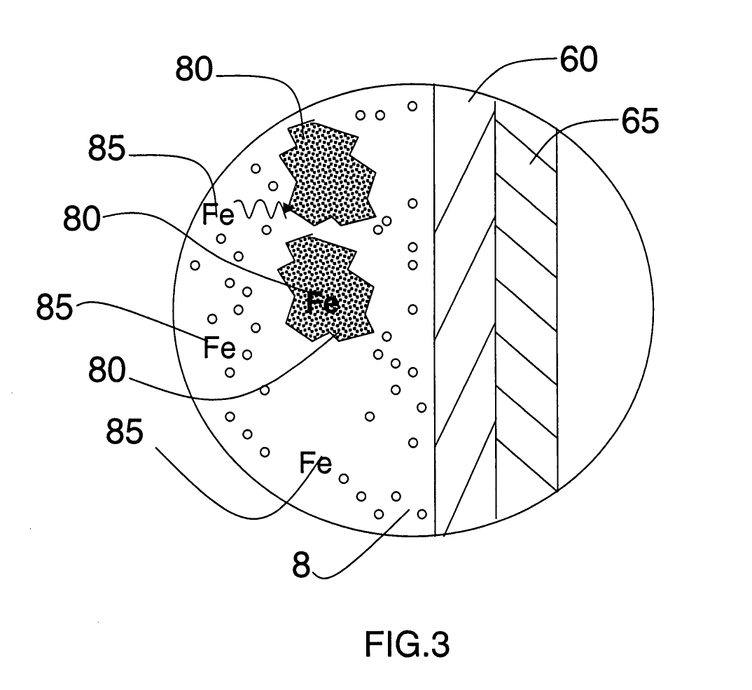

Referring to FIG. 1, there is illustrated a schematic view of a prior art system of a “hot fill” process 5 for bottling certain types of liquid nutrients 8 such as isotonic beverages having a pH equal to or greater than about 2.5 made in accordance with the prior art. Drinks such as Gatorade™ or PowerAide™, fruit drinks, and teas are examples of isotonic beverages. The bottling process typically begins with cleaned and sanitized containers such as bottles 12 formed from glass or using a polymer as described in FIGS. 2 and 3. The “hot fill” process of FIG. 1 may also be used for filling various other containers, for example but not limited to, bags, stand up pouches, juice boxes, cans, etc. After formulation, the beverage 8 is usually stored in a tank 10 until it is pumped via a pump 15 through a pasteurizer 20 to a filler station 25. Excess beverage may be pumped back to the tank 10 via line 26. Although these systems may integrate one or more functions, such systems are typically exposed in one way or another to the environment such that contaminants or other micro-organisms can enter into the filling or bottling process at one or more locations along the processing path 27. At the same time sanitized bottles 12 are also supplied to the filler station 25 wherein the beverage 8 is dispensed into the bottle 12. The bottle 12 is then moved to a capper 35 where the bottle 12 is sealed. Afterward the filled sealed bottle 12 is transported through a heating tunnel 40 where the beverage in the sealed bottle 12 is heated to a temperature typically about 180-200° F. The bottle 12 is then transported through a cooling tunnel 45 where it is inverted to insure the entire inside of the bottle 12 is subjected to the heated beverage before it is discharged to the packaging station 50, packaged and subsequently shipped at the shipping station 55.

Referring to FIG. 2, there is illustrated a cross-sectional view of a typical prior art container 12. The container 12 comprises the bottle 12 holding the liquid nutrient 8, for example the isotonic beverage. The container 12 may be made of one or more layers of a plastic polymer using various molding processes known by those skilled in the art. Examples of polymers used in the manufacture of plastic bottles are PET (polyethylene terephthalate), PP (polypropylene), LDPE (low density polyethylene) and HDPE (high density polyethylene). FIG. 3 illustrates a plastic bottle 12 formed using two different polymeric layers 60 and 65. However it is to be understood that the container 12 may comprise any desired number of layers.

The term inhibition of microbial-growth, or a material which “inhibits” microbial growth, is used by the authors to mean materials which either prevent microbial growth, or subsequently kills microbes so that the population is within acceptable limits, or materials which significantly retard the growth processes of microbes or maintain the level or microbes to a prescribed level or range. The prescribed level may vary widely depending upon the microbe and its pathogenicity; generally it is preferred that harmful organisms are present at no more than 10 organisms/ml and preferably less than 1 organism/ml. Antimicrobial agents which kill microbes or substantially reduce the population of microbes are often referred to as biocidal agents, while materials which simply slow or retard normal biological growth are referred to as biostatic agents. The preferred impact upon the microbial population may vary widely depending upon the application, for pathogenic organisms (such as E. coli O157:H7) a biocidal effect is more preferred, while for less harmful organisms a biostatic impact may be preferred. Generally, it is preferred that microbiological organisms remain at a level which is not harmful to the consumer or user of that particular article.

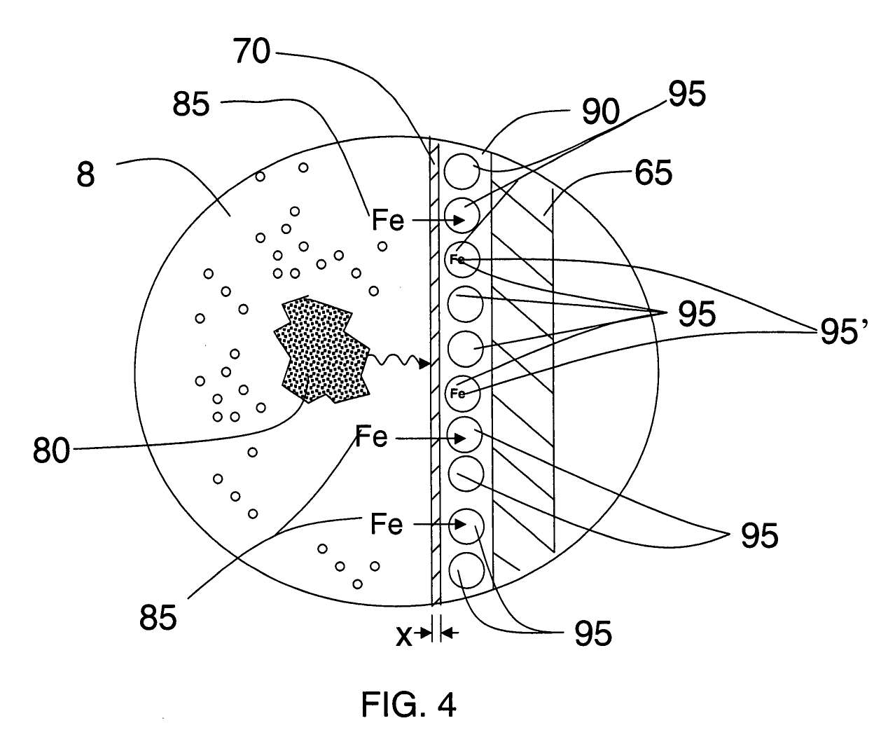

A fluid container, such as container 12 illustrated in FIG. 4 and discussed in greater detail later herein, made in accordance with the present invention is especially useful for containing a liquid nutrient, for example a beverage having a pH equal to or greater than about 2.5. The higher the pH, the more benefit is obtained from a container made in accordance with the present invention. Thus, if the pH is 3.0 or 4.0 or greater, the present invention will provide greater benefit. The container is designed to have an interior surface having a metal-ion sequestering agent for removing a designated metal-ion from a liquid nutrient for inhibiting growth of microbes in said liquid nutrient. It is preferred that the metal-ion sequestering agent is immobilized on the support structure and has a high-selectivity for biologically important metal-ions such as Mn, Zn, Cu and Fe. This is important because metal-ion sequestrants that are not immobilized may diffuse through the material or polymeric layers of the container and dissolve into the contents of the beverage. Metal-ions complexed by dissolved sequestrants will not be sequestered within the surfaces of the container but may be available for use by micro-organisms.

It is preferred that the fluid container made in accordance with the present invention comprises a polymer containing said metal-ion sequestrant. The container may comprise the polymer itself containing said metal-ion sequestrant, or alternatively, the metal-ion sequestrant may be contained with a polymeric layer attached to a support structure. It is preferred that said polymer is permeable to water. It is important that the polymer is permeable to water because permeability facilitates the contact of the target metal-ions with the metal-ion sequestrant, which in turn facilitates the sequestration of the metal-ions within the polymer or polymeric layer. A measure of the permeability of various polymeric addenda to water is given by the permeability coefficient, P that is given by
P=(quantity of permeate)(film thickness)/[area×time×(pressure drop across the film)]
Permeability coefficients and diffusion data of water for various polymers are discussed by J. Comyn, in Polymer Permeability, Elsevier, N.Y., 1985 and in “Permeability and Other Film Properties Of Plastics and Elastomers”, Plastics Design Library, NY, 1995. The higher the permeability coefficient, the greater the water permeability of the polymeric media. The permeability coefficient of a particular polymer may vary depending upon the density, crystallinity, molecular weight, degree of cross-linking, and the presence of addenda such as coating-aids, plasticizers, etc. It is preferred that the polymer has a water permeability of greater than 1000 [(cm³cm)/(cm²sec/Pa)]×10¹³. It is further preferred that the polymer has a water permeability of greater than 5000 [(cm³cm)/(cm²sec/Pa)]×10¹³. Preferred polymers for practice of the invention are polyvinyl alcohol, cellophane, water-based polyurethanes, polyester, nylon, high nitrile resins, polyethylene-polyvinyl alcohol copolymer, polystyrene, ethyl cellulose, cellulose acetate, cellulose nitrate, aqueous latexes, polyacrylic acid, polystyrene sulfonate, polyamide, polymethacrylate, polyethylene terephthalate, polystyrene, polyethylene, polypropylene or polyacrylonitrile. It is preferred that the metal-ion sequestrant comprises 0.1 to 50.0% by weight of the polymer, and more preferably 1% to 10% by weight of the polymer.

In a preferred embodiment, the container 12 comprises a plurality of layers having an outer layer having a metal-ion sequestering agent. In another preferred embodiment, the container comprises a plurality of layers comprising a barrier layer for contact with said beverage or foodstuff and an inner layer having said sequestering agent, said inner layer having a first side adjacent said barrier layer, and said barrier layer allowing liquid to pass thru to said inner layer. Multiple layers may be necessary to provide a rigid structure, able to contain foodstuffs, and to provide physical robustness. In a particular case there may be provided a second outer layer on the second side of said inner layer. It is preferred that both the first and second outer layer comprise a barrier layer that allows liquid to pass thru to said inner layer. The barrier layer does not contain the metal-ion sequestrant. However, the primary purpose of the barrier layer is to provide a barrier through which micro-organisms cannot pass. It is important to limit, or eliminate, the direct contact of micro-organisms with the metal-ion sequestrant or the layer containing the metal-ion sequestrant, since many micro-organisms, under conditions of iron deficiency, may bio-synthesize molecules which are strong chelators for iron, and other metals. These bio-synthetic molecules are called “siderophores” and their primary purpose is to procure iron for the micro-organisms. Thus, if the micro-organisms are allowed to directly contact the metal-ion sequestrant, they may find a rich source of iron there, and begin to colonize directly at these surfaces. The siderophores produced by the micro-organisms may compete with the metal-ion sequestrant for the iron (or other bio-essential metal) at their surfaces. The barrier layer of the invention does not contain the metal-ion sequestrant, and because micro-organisms are large, they may not pass or diffuse through the barrier layer. The barrier layer thus prevents contact of the micro-organisms with the polymeric layer containing the metal-ion sequestrant of the invention.

It is preferred that the metal-ion sequestrant has a high-affinity for biologically important metal-ions such as Mn, Mg, Zn, Cu and Fe. A measure of the “affinity” of metal-ion sequestrants for various metal-ions is given by the stability constant (also often referred to as critical stability constants, complex formation constants, equilibrium constants, or formation constants) of that sequestrant for a given metal-ion. Stability constants are discussed at length in “Critical Stability Constants”, A. E. Martell and R. M. Smith, Vols. 1-4, Plenum, NY (1977), “Inorganic Chemistry in Biology and Medicine”, Chapter 17, ACS Symposium Series, Washington, D.C. (1980), and by R. D. Hancock and A. E. Martell, Chem. Rev. vol. 89, p. 1875-1914 (1989). The ability of a specific molecule or ligand to sequester a metal-ion may depend also upon the pH, the concentrations of interfering ions, and the rate of complex formation (kinetics). Generally, however, the greater the stability constant, the greater the binding affinity for that particular metal-ion. Often the stability constants are expressed as the natural logarithm of the stability constant. Herein the stability constant for the reaction of a metal-ion (M) and a sequestrant or ligand (L) is defined as follows:
M+nL⇄MLₙ

where the stability constant is βₙ=[MLₙ]/[M][L]ⁿ, wherein [MLₙ] is the concentration of “complexed” metal-ion, [M] is the concentration of free (uncomplexed) metal-ion and [L] is the concentration of free ligand. The log of the stability constant is log βₙ, and n is the number of ligands, which coordinate with the metal. It follows from the above equation that if βₙ is very large, the concentration of “free” metal-ion will be very low. Ligands with a high stability constant (or affinity) generally have a stability constant greater than 10¹⁰ or a log stability constant greater than 10 for the target metal. Preferably the ligands have a stability constant greater than 10¹⁵ for the target metal-ion. Table 1 lists common ligands (or sequestrants) and the natural logarithm of their stability constants (log βₙ) for selected metal-ions.

TABLE 1
Common ligands (or sequestrants) and the natural
logarithm of their stability constants (log βₙ)
for selected metal-ions.

| Ligand | Ca | Mg | Cu(II) | Fe(III) | Al | Ag | Zn |
|---|---|---|---|---|---|---|---|
| alpha-amino | | | | | | | |
| carboxylates | | | | | | | |
| EDTA | 10.6 | 8.8 | 18.7 | 25.1 | | 7.2 | 16.4 |
| DTPA | 10.8 | 9.3 | 21.4 | 28.0 | 18.7 | 8.1 | 15.1 |
| CDTA | 13.2 | | 21.9 | 30.0 | | | |
| NTA | | | | 24.3 | | | |
| DPTA | 6.7 | 5.3 | 17.2 | 20.1 | 18.7 | 5.3 | |
| PDTA | 7.3 | | 18.8 | | | | 15.2 |
| citric Acid | 3.50 | 3.37 | 5.9 | 11.5 | 7.98 | 9.9 | |
| salicylic acid | | | | 35.3 | | | |
| Hydroxamates | | | | | | | |
| Desferroxamine B | | | | 30.6 | | | |
| acetohydroxamic | | | | 28 | | | |
| acid | | | | | | | |
| Catechols | | | | | | | |
| 1,8-dihydroxy | | | | 37 | | | |
| naphthalene | | | | | | | |
| 3,6 sulfonic acid | | | | | | | |
| MECAMS | | | | 44 | | | |
| 4-LICAMS | | | | 27.4 | | | |
| 3,4-LICAMS | 16.2 | | | 43 | | | |
| 8-hydroxyquinoline | | | | 36.9 | | | |
| disulfocatechol | 5.8 | 6.9 | 14.3 | 20.4 | 16.6 | | |

EDTA is ethylenediamine tetra acetic acid and salts thereof, DTPA is diethylenetriaminepentaacetic acid and salts thereof, DPTA is Hydroxylpropylenediaminetetraacetic acid and salts thereof, NTA is nitrilotriacetic acid and salts thereof, CDTA is 1,2-cyclohexanediamine tetra acetic acid and salts thereof, PDTA is propylenediammine tetra acetic acid and salts thereof. Desferroxamine B is a commercially available iron chelating drug, desferal®. MECAMS, 4-LICAMS and 3,4-LICAMS are described by Raymond et al. in “Inorganic Chemistry in Biology and Medicine”, Chapter 18, ACS Symposium Series, Washington, D.C. (1980). Log stability constants are from “Critical Stability Constants”, A. E. Martell and R. M. Smith, Vols. 1-4, Plenum Press, NY (1977); “Inorganic Chemistry in Biology and Medicine”, Chapter 17, ACS Symposium Series, Washington, D.C. (1980); R. D. Hancock and A. E. Martell, Chem. Rev. vol. 89, p. 1875-1914 (1989) and “Stability Constants of Metal-ion Complexes”, The Chemical Society, London, 1964.

In many instances, the growth of a particular micro-organism may be limited by the availability of a particular metal-ion, for example, due to a deficiency of this metal-ion. In such cases it is desirable to select a metal-ion sequestrant with a very high specificity or selectivity for a given metal-ion. Metal-ion sequestrants of this nature may be used to control the concentration of the target metal-ion and thus limit the growth of the organism(s), which require this metal-ion. However, it may be necessary to control the concentration of the target metal, without affecting the concentrations of beneficial metal-ions such as potassium and calcium. One skilled in the art may select a metal-ion sequestrant having a high selectivity for the target metal-ion. The selectivity of a metal-ion sequestrant for a target metal-ion is given by the difference between the log of the stability constant for the target metal-ion, and the log of the stability constant for the interfering (beneficial) metal-ions. For example, if a treatment required the removal of Fe(III), but it was necessary to leave the Ca-concentration unaltered, then from Table 1, DTPA would be a suitable choice since the difference between the log stability constants 28−10.8=17.2, is very large. 3,4-LICAMS would be a still more suitable choice since the difference between the log stability constants 43−16.2=26.8, is the largest in Table 1.

It is preferred that said metal-ion sequestrant has a high-affinity for iron, and in particular iron(III). It is preferred that the stability constant of the sequestrant for iron(III) be greater than 10¹⁰. It is still further preferred that the metal-ion sequestrant has a stability constant for iron greater than 10²⁰. It is still further preferred that the metal-ion sequestrant has a stability constant for iron greater than 10³⁰.

It is preferred that the container comprises derivatized nanoparticles comprising inorganic nanoparticles having an attached metal-ion sequestrant, wherein said inorganic nanoparticles have an average particle size of less than 200 nm and the derivatized nanoparticles have a stability constant greater than 10¹⁰ with iron (III). It is further preferred that the derivatized nanoparticles have a stability constant greater than 10²⁰ with iron (III). The derivatized nanoparticles are preferred because they have very high surface area and may have a very high-affinity for the target metal-ions. It is preferred that the nanoparticles have an average particle size of less than 100 nm. It is further preferred that the nanoparticles have an average size of less than 50 nm, and most preferably less than 20 nm. Preferably greater than 95% by weight of the nanoparticles are less than 200 nm, more preferably less than 100 nm, and most preferably less than 50 nm. This is preferred because as the particle size becomes smaller, the particles scatter visible-light less strongly. Therefore, the derivatized nanoparticles can be applied to clear, transparent surfaces without causing a hazy or a cloudy appearance at the surface. This allows the particles of the present invention to be applied to packaging materials without changing the appearance of the item. It is preferred that the nanoparticles have a very high surface area, since this provides more surface with which to covalently bind the metal-ion sequestrant, thus improving the capacity of the derivatized nanoparticles for binding metal-ions. It is preferred that the nanoparticles have a specific surface area of greater than 100 m²/g, more preferably greater than 200 m²/g, and most preferably greater than 300 m²/g. For applications of the invention in which the concentrations of contaminant or targeted metal-ions in the environment are high, it is preferred that the nanoparticles have a particle size of less than 20 nm and a surface area of greater than 300 m²/g. Derivatized nanoparticles are described at length in co-pending U.S. patent application Ser. No. 10/822,940 filed Apr. 13, 2004 by Joseph F. Bringley.

It is preferred that the derivatized nanoparticles have a high stability constant for the target metal-ion(s). The stability constant for the derivatized nanoparticle will largely be determined by the stability constant for the attached metal-ion sequestrant. However, the stability constant for the derivatized nanoparticles may vary somewhat from that of the attached metal-ion sequestrant. Generally, it is anticipated that metal-ion sequestrants with high stability constants will give derivatized nanoparticles with high stability constants. For a particular application, it may be desirable to have a derivatized nanoparticle with a high selectivity for a particular metal-ion. In most cases, the derivatized nanoparticle will have a high selectivity for a particular metal-ion if the stability constant for that metal-ion is about 10⁶ greater than for other ions present in the system.

Metal-ion sequestrants may be chosen from various organic molecules. Such molecules having the ability to form complexes with metal-ions are often referred to as “chelators”, “complexing agents”, and “ligands”. Certain types of organic functional groups are known to be strong “chelators” or sequestrants of metal-ions. It is preferred that the sequestrants of the invention contain alpha-amino carboxylates, hydroxamates, or catechol, functional groups. Hydroxamates, or catechol, functional groups are preferred. Alpha-amino carboxylates have the general formula:
R—[N(CH₂CO₂M)-(CH₂)ₙ—N(CH₂CO₂M)₂]ₓ
where R is an organic group such as an alkyl or aryl group; M is H, or an alkali or alkaline earth metal such as Na, K, Ca or Mg, or Zn; n is an integer from 1 to 6; and x is an integer from 1 to 3. Examples of metal-ion sequestrants containing alpha-amino carboxylate functional groups include ethylenediaminetetraacetic acid (EDTA), ethylenediaminetetraacetic acid disodium salt, diethylenetriaminepentaacetic acid (DTPA), Hydroxylpropylenediaminetetraacetic acid (DPTA), nitrilotriacetic acid, triethylenetetraaminehexaacetic acid, N,N′-bis(o-hydroxybenzyl)ethylenediamine-N,N′ diacteic acid, and ethylenebis-N,N′-(2-o-hydroxyphenyl)glycine.

Hydroxamates (or often called hydroxamic acids) have the general formula: 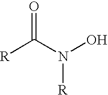
where R is an organic group such as an alkyl or aryl group. Examples of metal-ion sequestrants containing hydroxamate functional groups include acetohydroxamic acid, and desferroxamine B, the iron chelating drug desferal.

Catechols have the general formula: 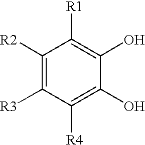
Where R1, R2, R3 and R4 may be H, an organic group such as an alkyl or aryl group, or a carboxylate or sulfonate group. Examples of metal-ion sequestrants containing catechol functional groups include catechol, disulfocatechol, dimethyl-2,3-dihydroxybenzamide, mesitylene catecholamide (MECAM) and derivatives thereof, 1,8-dihydroxynaphthalene-3,6-sulfonic acid, and 2,3-dihydroxynaphthalene-6-sulfonic acid.

In a preferred embodiment the metal-ion sequestrant is attached to a nanoparticle by reaction of the nanoparticle with a silicon alkoxide intermediate having the general formula:
Si(OR)₄₋ₓR′ₓ;
wherein x is an integer from 1 to 3;
R is an alkyl group; and R′ is an organic group containing an alpha amino carboxylate, a hydroxamate, or a catechol. The —OR-group attaches the silicon alkoxide to the core particle surface via a hydrolysis reaction with the surface of the particles. Materials suitable for practice of the invention include N-(trimethoxysilylpropyl)ethylenediamine triacetic acid, trisodium salt, N-(triethoxysilylpropyl)ethylenediamine triacetic acid, trisodium salt, N-(trimethoxysilylpropyl)ethylenediamine triacetic acid, N-(trimethoxysilylpropyl)diethylenetriamine tetra acetic acid, N-(trimethoxysilylpropyl)amine diacetic acid, and metal-ion salts thereof.

The antimicrobial active material of antimicrobial agent may be selected from a wide range of known antibiotics and antimicrobials. An antimicrobial material may comprise an antimicrobial ion, molecule and/or compound, metal ion exchange materials exchanged or loaded with antimicrobial ions, molecules and/or compounds, ion exchange polymers and/or ion exchange latexes, exchanged or loaded with antimicrobial ions, molecules and/or compounds. Suitable materials are discussed in “Active Packaging of Food Applications” A. L. Brody, E. R. Strupinsky and L. R. Kline, Technomic Publishing Company, Inc. Pennsylvania (2001). Examples of antimicrobial agents suitable for practice of the invention include benzoic acid, sorbic acid, nisin, thymol, allicin, peroxides, imazalil, triclosan, benomyl, metal-ion release agents, metal colloids, anhydrides, and organic quaternary ammonium salts. Preferred antimicrobial reagents are metal ion exchange reagents such as silver sodium zirconium phosphate, silver zeolite, or silver ion exchange resin which are commercially available. The antimicrobial agent may be provided in a layer 15 having a thickness “y” of between 0.1 microns and 100 microns, preferably in the range of 1.0 and 25 microns.

In another preferred embodiment, the antimicrobial agent comprising a composition of matter comprising an immobilized metal-ion sequestrant/antimicrobial comprising a metal-ion sequestrant that has a high stability constant for a target metal ion and that has attached thereto an antimicrobial metal-ion, wherein the stability constant of the metal-ion sequestrant for the antimicrobial metal-ion is less than the stability constant of the metal-ion sequestrant for the target metal-ion. These are explained in detail in co-pending U.S. patent application Ser. No. 10/868,626 filed Jun. 15, 2004, by Joseph F. Bringley, et al., hereby included by reference.

In a preferred embodiment, the antimicrobial agent comprising a metal ion exchange material is exchanged with at least one antimicrobial metal ion selected from silver, copper, gold, nickel, tin or zinc.

Referring to FIG. 4, there is illustrated an enlarged partial cross section view of the wall of a fluid container 12 made in accordance with the present invention. The wall of the container 12, which in the embodiment illustrated is a bottle, is made of a material that comprises a barrier layer 70, an outer polymeric layer 65, and an inner polymeric layer 90 between said barrier layer 70 and outer polymeric layer 65. The inner polymeric layer 90 contains a metal-ion sequestrant 95. The barrier layer 70 preferably does not contain the metal-ion sequestrant 95. The outer layer 65 may provide several functions including improving the physical strength and toughness of the article and resistance to scratching, marring, cracking, etc. However, the primary purpose of the barrier layer 70 is to provide a barrier through which micro-organisms 80, present in the contained fluid, cannot pass. It is important to limit, or eliminate, in certain applications, the direct contact of micro-organisms 80 with the metal-ion sequestrant 95 or the layer 90 containing the metal-ion sequestrant 95, since many micro-organisms 80, under conditions of iron deficiency, may bio-synthesize molecules which are strong chelators for iron, and other metals. These bio-synthetic molecules are called “siderophores” and their primary purpose is to procure iron for the micro-organisms 80. Thus, if the micro-organisms 80 are allowed to directly contact the metal-ion sequestrant 95, they may find a rich source of iron there, and begin to colonize directly at these surfaces. The siderophores produced by the micro-organisms may compete with the metal-ion sequestrant for the “free” iron ion 85 (or other bio-essential metal) at their surfaces. However, the energy required for the organisms to adapt their metabolism to synthesize these siderophores will impact significantly their growth rate. Thus, one object of the invention is to lower growth rate of organisms in the contained liquid. Since the barrier layer 70 of the invention does not contain the metal-ion sequestrant 95, and because micro-organisms 80 are large, the micro-organisms 80 may not pass or diffuse through the barrier layer 70. The barrier layer 70 thus prevents contact of the micro-organisms 80 with the polymeric layer 90 containing the metal-ion sequestrant 95 of the invention. It is preferred that the barrier layer 70 is permeable to water. It is preferred that the barrier layer 70 has a thickness “x” in the range of 0.1 microns to 10.0 microns. It is preferred that microbes are unable to penetrate, to diffuse or pass through the barrier layer 70. Sequestrant 95 with a sequestered metal-ion is indicated by numeral 95′.

Still referring to FIG. 4, the enlarged sectioned view of the fluid container 12 shown in FIG. 2, illustrates a bottle having barrier layer 70, which is in direct contact with the contained beverage 8, an inner polymeric layer 90 and an outer polymeric layer 65. However, the prior art bottle of FIG. 3 comprises an inner polymeric layer 60 that does not contain any metal-ion sequestering agents according to the present invention. In the prior art bottle illustrated in FIG. 3, the micro-organisms 80 are free to gather the “free” iron ions 85. In the bottle according to the present invention shown in FIG. 4, the inner polymer 90 contains an immobilized metal-ion sequestering agent 95 such as EDTA. In order for the metal-ion sequestering agent 95 to work properly, the inner polymer 90 containing the metal-ion sequestering agent 95 must be permeable to the aqueous solution or beverage 8. Preferred polymers for layers 70 and 90 of the invention are polyvinyl alcohol, cellophane, water-based polyurethanes, polyester, nylon, high nitrile resins, polyethylene-polyvinyl alcohol copolymer, polystyrene, ethyl cellulose, cellulose acetate, cellulose nitrate, aqueous latexes, polyacrylic acid, polystyrene sulfonate, polyamide, polymethacrylate, polyethylene terephthalate, polystyrene, polyethylene, polypropylene or polyacrylonitrile. A water permeable polymer permits water to move freely through the polymer 90 allowing the “free” iron ion 85 to reach and be captured by the agent 95. An additional barrier 70 may be used to prevent the micro-organism 80 from reaching the inner polymer material 90 containing the metal-ion sequestering agent 95 and the sequestered metal-ion 95′. Like the inner polymer material 90, the barrier layer 70 must be made of a water permeable polymer as previously described. The micro-organism 80 is too large to pass through the barrier 70 or the inner polymer layer 90 so it cannot reach the sequestered iron ion 95′ now held by the metal-ion sequestering agent 95. By using the metal-ion sequestering agents 95 to significantly reduce the amount of “free” iron ions 85 in the beverage 8, the growth of the micro-organism 80 is eliminated or severely reduced.

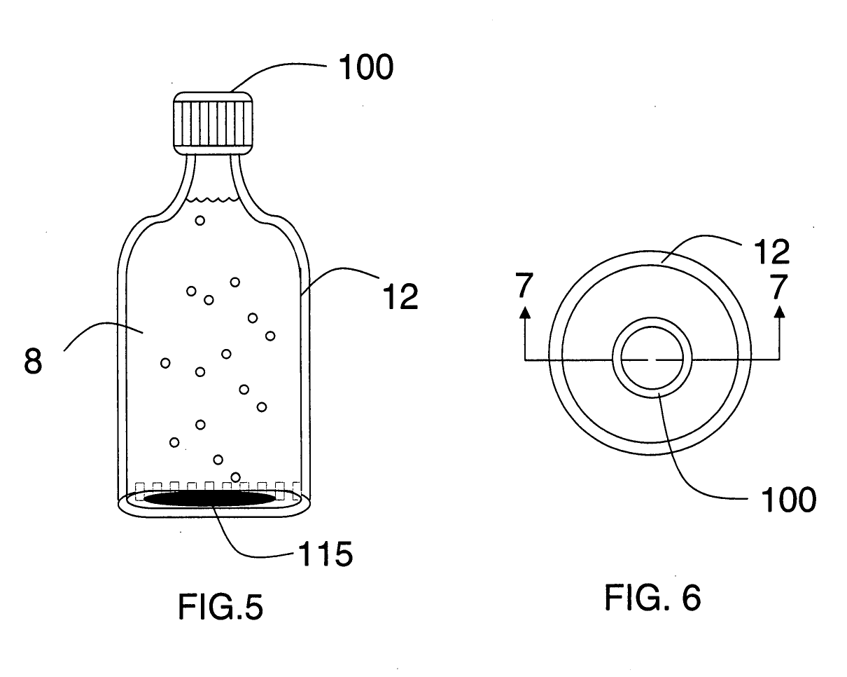

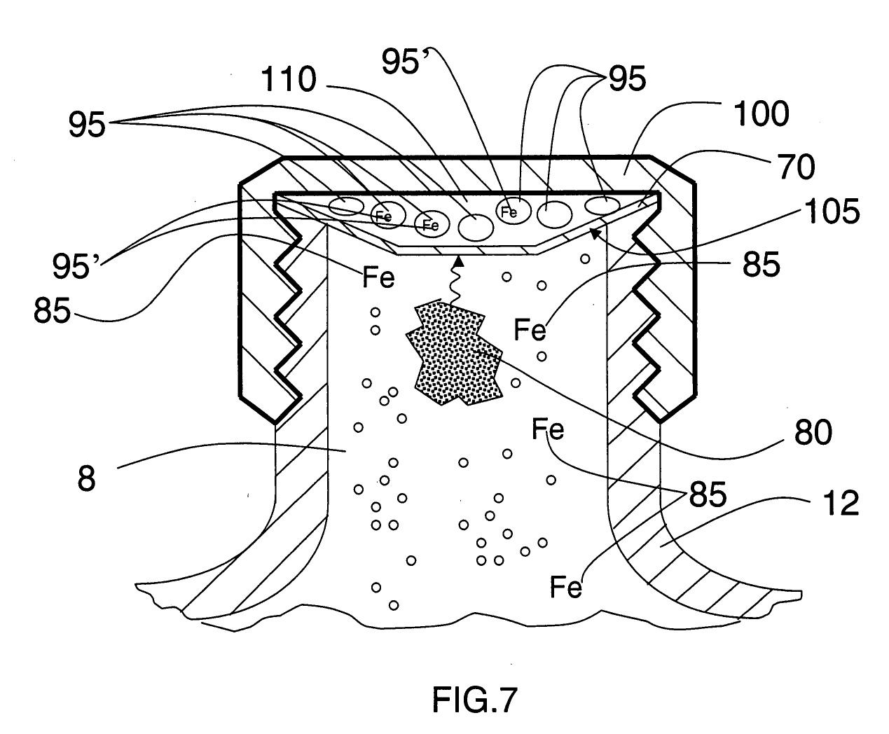

In the embodiment shown in FIGS. 5, 6, and 7 the metal-ion sequestering agent 95 is contained in the bottle cap 100 instead of on the inside surface of the bottle 12. An inner portion 105 of the cap 100, which is in intimate contact with the beverage 8, is made of a hydrophilic polymer 110 containing the metal-ion sequestering agent 95 such as EDTA as described above. In some situations, the bottle 8 may need to be placed in the inverted position in order for the sequestrant to come in contact with the contained nutrient. The cap 100 may also have the barrier layer 70 to further prevent the micro-organisms 80 from reaching the sequestered “free” iron ion 95′. In another embodiment (not shown) the cap sealing material could be an open cell foamed structure whose cell walls are coated with the sequestering material.

In another embodiment of the present invention, the sequestering agent 95 may be in a hydrophilic polymeric insert 115 that is placed in the bottle 12 as illustrated in FIG. 5. The insert 115 may be instead of or in addition to the sequestrant in the cap 100 or interior of the bottle. The insert 115 is placed in the bottle 12 but unfolds making it too large to exit the bottle 12. In another version, the insert 115 is molded into the bottom of the bottle 12.

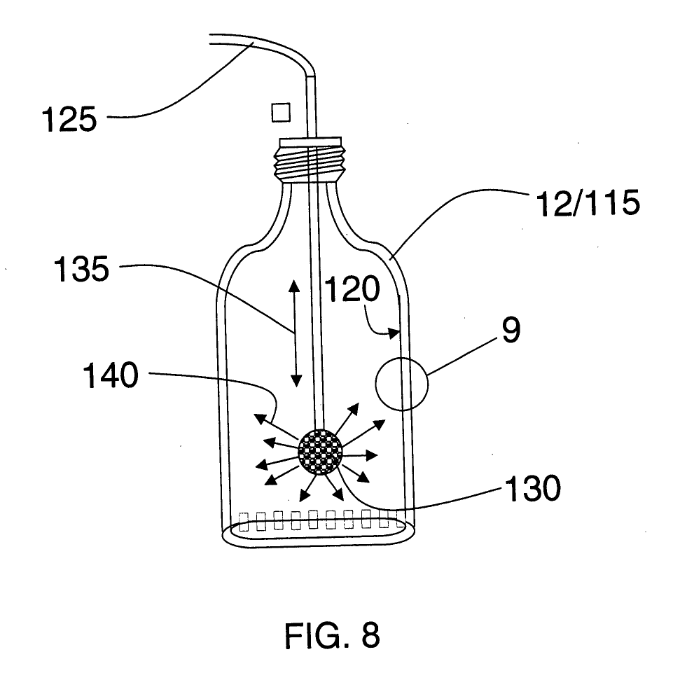

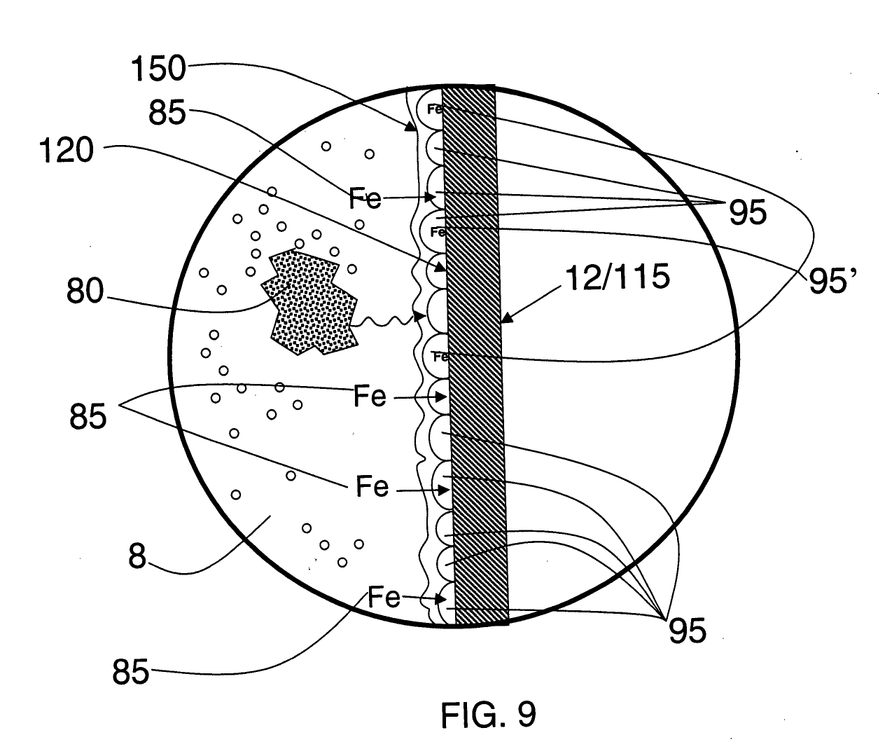

Referring to FIGS. 8 and 9, there is illustrated yet another embodiment of a bottle 12 made in accordance with the present invention. In this embodiment, the metal-ion sequestering agent 95 is applied to the interior surface 120 of the bottle 12 by spraying a metal-ion sequestering agent 95, for example EDTA, on to the interior surface 120 of the bottle 12, through a supply tube 125 using a spherical shaped nozzle assembly 130. The nozzle assembly 130 is moved up and down in the direction of the arrow 135 while the metal-ion sequestering agent 95 is sprayed as indicated by the arrows 140. It is to be understood that any method of applying coatings to glass, metal or plastic containers may be used as is well known to those skilled in the art of applying such coating. FIG. 9 illustrates an enlarged partial cross sectional view of the portion of the bottle of FIG. 8 where the spray coating 150 of the metal-ion sequestering agent 95 has been applied. As previously discussed in FIG. 4 like numerals indicate like parts and operations. It is of course understood that the inner layer containing the sequestrant may be applied or formed on the inside surface of the container in any appropriate manner. The bottle 12 in this embodiment may be made of any appropriate plastic or glass material. While in the embodiment illustrated substantially the entire interior surface 120 is coated with the metal-ion sequestering agent 95, the present invention is not so limited. Only that portion of the interior surface need be coated as necessary for requesting the desired free metal-ion and any appropriate pattern.

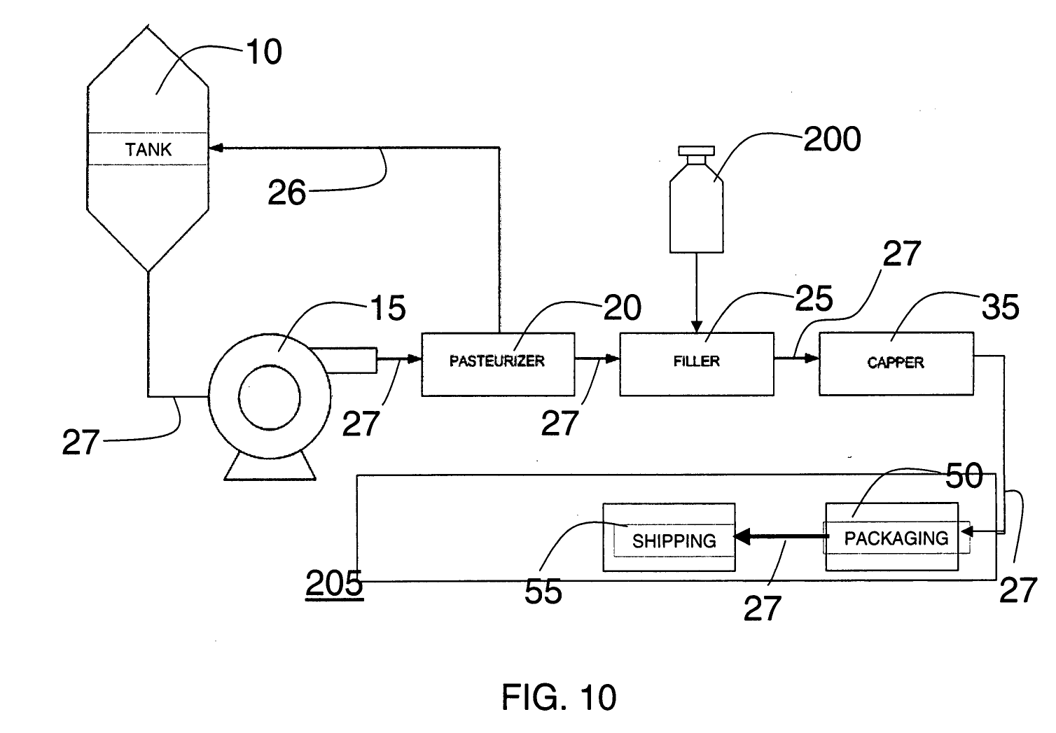

By using the metal-ion sequestering agents 95 to remove “free” iron 85 as the method for eliminating the micro-organisms 80 that enter the bottles 12 between the filling station 25 and the capper 30, the “hot fill” portion 40 of the process shown in FIG. 1 is no longer necessary. The use of bottles 200, bags, stand up pouches, juice boxes, cans, etc containing metal-ion sequestering agents 95 as described in FIGS. 4 through 9, the process 205 shown in FIG. 10 may be used for bottling the types of beverages and foodstuffs requiring the “hot fill” process. The process of FIG. 10 is similar to that of FIG. 1, like numbers indicate like parts and operations as previously discussed, except that the heating tunnel 40 where the beverage is heated and the cooling tunnel 45 for cooling of the heated bottles are eliminated as they are not needed or is significantly reduced. By removing and/or significantly reducing the “hot fill” portion 40 (shown in FIG. 1) of the process 205, the amount of energy required for both heating and cooling the bottles during the filling process is greatly reduced while increasing the options in both bottle design and materials to be used in the bottling process. Depending on the liquid being bottled and the iron-sequestering agent and/or antimicrobial agent being utilized, some heating and cooling may be required but at significantly reduced level whereby a direct a significantly economic benefit will be realized.

For example, a saving as little as about one cent ($0.01) may be realized, this would be very significant as a typically bottling plant will fill millions of bottles per year. It is of course understood that the certain processes of FIG. 10 may be further modified or eliminated depending on the type of container being used. For example, where a drink box, drink bag, can, is used, a different type of filler or capping/closure device may be utilized as required.

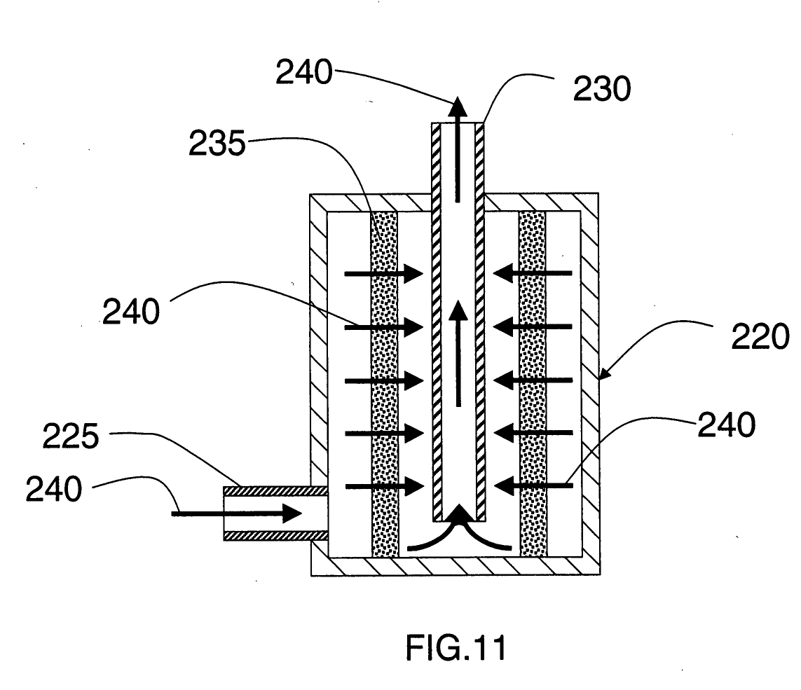

Referring to FIG. 11, there is illustrated a cross-sectional view of a filter assembly 220 comprising an inlet port 225, an outlet port 230, and a filter 235. The filter 235 contains an immobilized metal-ion sequestering agent as previously described. As the solution flows through the filter assembly 220 in the direction indicated by the arrows 240, and through the filter 235 the metal ions in the solution are sequestered and removed by the metal-ion sequestering agent 245.

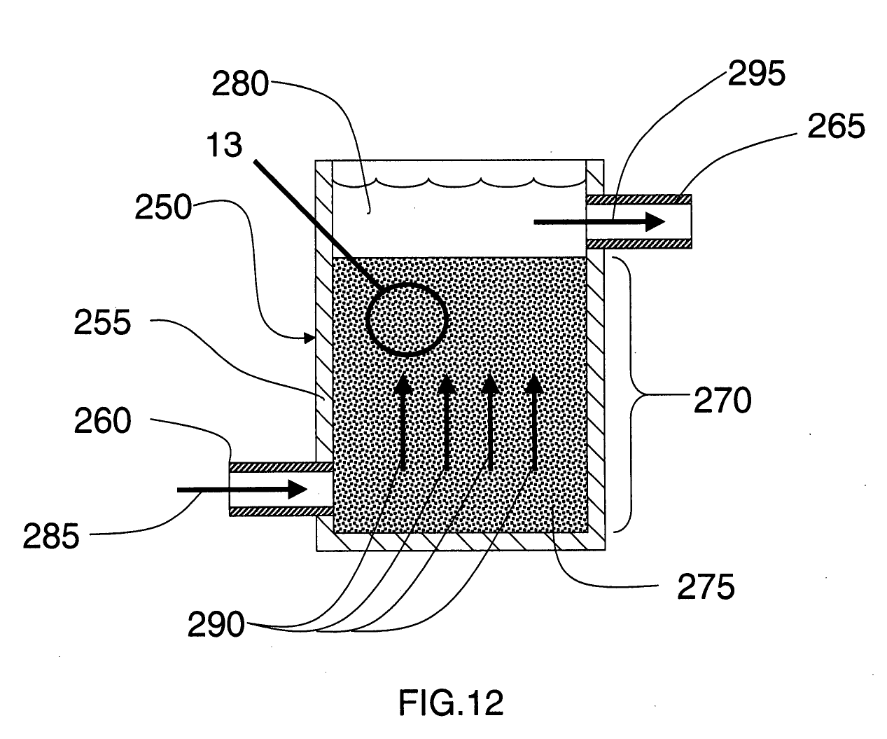

Referring to FIG. 12, there is illustrated a cross sectional view of a fluid bed ion exchange assembly 250 comprising a holding tank 255, an inlet port 260, an outlet port 265, and a fluid bed 270 containing a metal-ion sequestering material 275 made in accordance with the present invention. The solution 280 flows into the fluid bed ion exchange assembly 250 via inlet port 260 as indicated by arrow 285 through the metal-ion sequestering material 275 in fluid bed 270 as indicated by arrows 290 and out the outlet port as indicated by arrow 295.

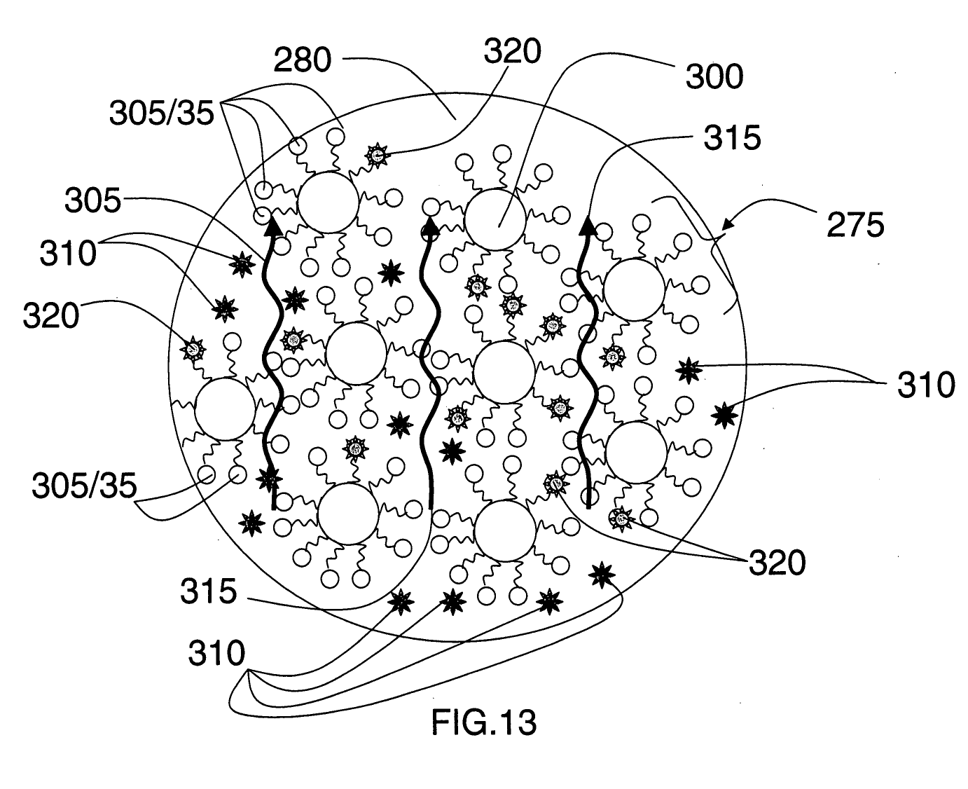

FIG. 13 is an enlarged partial view of a portion of the fluid bed 270 containing a metal-ion sequestering material 275. An example of the metal-ion sequestering material 275 comprises a core material 300 and a shell material 305 made of the metal-ion sequestering agent 35 as described in co-pending U.S. patent application Ser. No. 10/822,940 filed Apr. 13, 2004 entitled ARTICLE FOR INHIBITING MICROBIAL GROWTH by Joseph F. Bringley et al. As previously described above in FIG. 21, the solution 280 containing “free” metal ions 310 flows through the fluid bed 270 as indicated by the arrows 315. As the solution 280 flows through the fluid bed 270 the shell material 305 made of the metal-ion sequestering agent 35 gathers the metal ions 320 removing them from the solution, which then flow out through the outlet port 265.

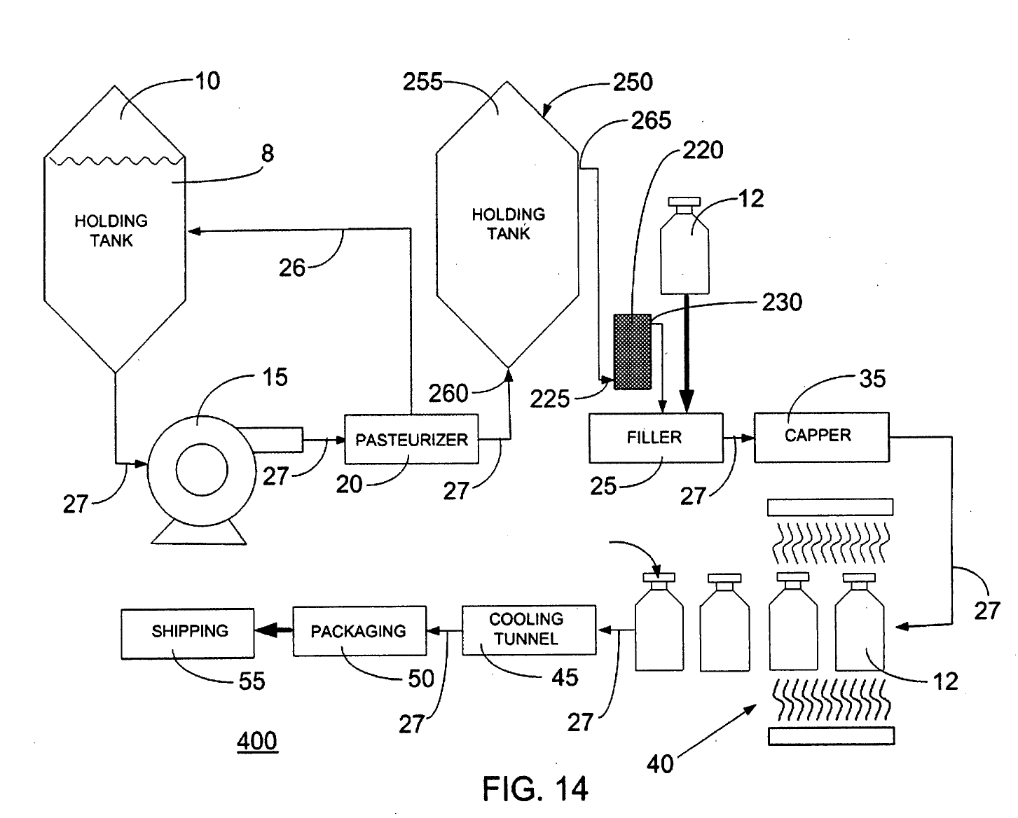

The process of FIG. 14 is similar to that of FIGS. 1, 11, 12, and 13 like numbers indicate like parts and operations as previously discussed, except that the heating tunnel 40 where the beverage is heated and the cooling tunnel 45 for cooling of the heated bottles are eliminated as they are not needed or the heating tunnel 40 and cooling tunnel 45 are significantly reduced. By removing and/or significantly reducing the “hot fill” portion of the process 400, the amount of energy required for both heating and cooling the bottles during the filling process is greatly reduced while increasing the options in both bottle design and materials to be used in the bottling process. Depending on the liquid being bottled and the iron-sequestering agent and/or antimicrobial agent being utilized, some heating and cooling may be required, but at significantly reduced levels whereby a direct significantly economic benefit will be realized. For example, a saving as little as about one cent ($0.01) per bottle may be realized, this would be very significant as a typical bottling plant will fill millions of bottles per year. In the process shown in FIG. 14, depending on the “free” metal ions 310 to be sequestered, for example Mn, Mg, Zn, Cu and Fe, the filter assembly 220 and/or the fluid bed ion exchange assembly 250 may be used to eliminate or reduce metal ions in conjunction with the metal ion sequestering agent in the container, or may be used alone to remove the metal ions. It is of course understood that the certain processes of FIG. 14 may be further modified or eliminated depending on the type of container being used. For example, where a drink box, drink bag, can, is used, a different type of filler or capping/closure device may be utilized as required.

It maybe desirable to remove more than one metal ion, depending on the product being processed. For example, when processing apple juice, it is advantageous to lower the concentration of the “free iron” ion to below 10 ppb, while lowering the level of Mg ions to below one ppm. In the embodiment shown in FIG. 14, the Mg ions maybe sequestered by pumping the liquid after pasteurizer 20, in this case apple juice, into the holding tank 255 containing the fluid bed exchange assembly 250. The fluid bed exchange assembly 250 is better at removing the Mg because of the large amount of Mg present to begin with in the apple juice. While the fluid bed exchange assembly 250 is removing the Mg, it also may remove some of the “free iron” ions. In the case of removing the “free iron” ions, however, they may be more effectively removed using the filter assembly 220, with a filter material designed to specifically sequester the “free iron” ions while not being saturated with the Mg. Because the “free iron” must be reduced to a low level, (much lower than the Mg) the filter assembly 220 can take the “free iron” ions down to a level close to the 10 ppb and the “free iron” ion sequestering agent in the container can be used to further reduce the “free iron” ion further to below the desired 10 ppb. It should be understood that depending on the liquid being processed and the type and concentration of metal ion being removed, a number of combinations of fluid bed exchange assemblies, filter assemblies, and sequestering agents maybe used in conjunction with the sequestering agent present in the structure of the container.

The invention has been described in detail with particular reference to certain preferred embodiments thereof, but it will be understood that variations and modifications can be effected within the scope of the invention, the present invention being defined by the claim set forth herein.

### Parts List

5 process
8 beverage
10 tank
12 container/bottle
15 pump
20 pasteurizer
25 filler station
26 line
27 processing path
30 barrier layer
35 capper
40 heating tunnel
45 cooling tunnel
50 packing station
55 shipping station
60 inner polymer material
65 outer polymer material
70 barrier layer
80 micro-organism
85 “free” iron ion
90 inner polymer
95 metal-ion sequestering agent
95′ sequestered metal-ion
100 cap
105 inner portion
110 hydrophilic layer
115 insert
120 inside surface
125 supply tube
130 nozzle assembly
135 arrow
140 arrow
150 spray coating
205 process
220 filter assembly
225 inlet port
230 outlet port
235 filter
240 arrow
250 fluid bed ion exchange assembly
255 holding tank
260 inlet port
265 outlet port
270 fluid bed
275 sequestering material
280 solution
285 arrow
290 arrow
295 arrow
300 core material
305 shell material
310 “free” metal ions
315 arrows
320 metal ions
400 process

1. A method of removing a selected metal-ion from a solution, comprising the steps of:
a. subjecting a liquid to a first metal-ion sequestering agent for removing a first designated metal ion prior to placing said liquid in a container;
b. providing said container for holding said liquid, said container having an internal surface having a second metal-ion sequestering agent provided on at least a portion of said internal surface for removing a second designated metal-ion from said liquid;
c. filling said container with said liquid in an open environment; and
d. closing said container with said liquid contained therein.

2. The method according to claim 1 wherein after closing said container, said container is subjected to heating and cooling process less than normally required for sterilization of said liquid.

3. The method according to claim 1 wherein said first and second designated metal ions are the same, and wherein said subjecting said liquid to said first designated metal-ion sequestering agent reduces said first metal ion concentration in said liquid to a first level and second designated metal-ion sequestering agents reduces the concentration of said first metal ion in said liquid to a second lower level.

4. The method according to claim 1 wherein said first designated metal ion is different from said second designated metal ion.

5. The method according to claim 1 wherein said first designated metal ion is the same as said second designated metal ion.

6. The method according to claim 4 wherein said first designated metal ion comprises Mg.

7. The method according to claim 6 wherein said second designated metal ion comprises Fe.

8. The method according to claim 1 wherein said first designated metal ion comprises two or more metal ions.

9. The method according to claim 8 wherein said two or more metal ions comprise Fe and Mg.

10. The method according to claim 8 wherein said two or more metal ions are selected from the following group:
Fe, Mg, Zn, Ca, Cu and Mn.

11. The method according to claim 1 wherein said container comprises a bottle and cap assembly.

12. The method according to claim 11 wherein said bottle is made of a plastic material.

13. The method according to claim 11 wherein said second metal-ion sequestering agent is provided on the internal surface of said bottle.

14. The method according to claim 11 wherein said bottle is made of a material that includes said second metal-ion sequestering agent.

15. The method according to claim 11 wherein said second metal-ion sequestering agent is provided on the internal surface of said cap.

16. The method according to claim 1 wherein said liquid has a H equal to or greater than about 3.

17. A method according to claim 1 wherein said first and/or second metal ion sequestering agents include an antimicrobial agent.

18. The method according to claim 17 wherein said antimicrobial agent comprises an antimicrobial active material selected from benzoic acid, sorbic acid, nisin, thymol, allicin, peroxides, imazalil, triclosan, benomyl, metal-ion release agents, metal colloids, anhydrides, and organic quaternary ammonium salts, a metal ion exchange reagents such as silver sodium zirconium phosphate, silver zeolite, or silver ion exchange resin.

19. The method according to claim 1 wherein said second metal-ion sequestering agent is immobilized on the surface(s) of said container and has a stability constant greater than 10¹⁰ with iron (III).

20. The method according to claim 1 wherein said second metal ion sequestering agent is immobilized on the surface(s) of said container and has a high-affinity for biologically important metal-ions such as Mn, Zn, Cu and Fe.

21. The method according to claim 1 wherein said first or second sequestering agent has a high-selectively for certain metal-ions but a low-affinity for at least one other ion.

22. The method according to claim 1 wherein said first or second metal-ion sequestering agent is immobilized on the surface(s) of said container and has a stability constant greater than 10¹⁰ with iron (III) and said antimicrobial agent comprises an antimicrobial active material selected from benzoic acid, sorbic acid, nisin, thymol, allicin, peroxides, imazalil, triclosan, benomyl, metal-ion release agents, metal colloids, anhydrides, and organic quaternary ammonium salts.

23. The method according to claim 1 wherein said first or second metal-ion sequestering agent is immobilized on the surface(s) of said container and has a stability constant greater than 10²⁰ with iron (III).

24. The method according to claim 1 wherein said first or second metal-ion sequestering agent is immobilized on the surface(s) of said container and has a stability constant greater than 10¹⁰ with iron (III) and said antimicrobial agent comprises a metal ion selected from one of the following:
silver;
copper;
gold;
nickel;
tin;
zinc.

25. The method according to claim 1 wherein said first or second metal-ion sequestering agent comprises derivatized nanoparticles comprising inorganic nanoparticles having an attached metal-ion sequestrant, wherein said inorganic nanoparticles have an average particle size of less than 200 nm and the derivatized nanoparticles have a stability constant greater than 10¹⁰ with iron (III).

26. The method according to claim 1 wherein said subjecting said liquid to said first metal-ion sequestering agent occurs in an ion bed exchange device.

27. The method according to claim 1 wherein said subjecting said liquid to said first metal-ion sequestering agent occurs in a filter device.

28. A method of removing a selected two or more different metal-ions from a solution, comprising the steps of:
a. subjecting a liquid to a first metal-ion sequestering agent for removing a first designated metal ion prior to placing said liquid in a container;
b. providing said container for holding said liquid, said container having an internal surface having a second metal-ion sequestering agent provided on at least a portion of said internal surface for removing a second designated metal-ion from said liquid, said second designated metal ion being different from said first designated metal ion;
c. filling said container with said liquid in an open environment; and
d. closing said container with said liquid contained therein.

29. The method according to claim 28 wherein after closing said container, said container is subjected to heating and cooling process less than normally required for sterilization of said liquid.

30. The method according to claim 28 wherein said first metal-ion sequestering agent also removes said second designated metal ion, subjecting said liquid to said first designated metal-ion sequestering agent reducing said second metal ion concentration in said liquid to a first level and second designated metal-ion sequestering agents reduces the concentration of said second designated metal ion in said liquid to a second lower level.

31. The method according to claim 28 wherein said first designated metal ion comprises Mg.

32. The method according to claim 31 wherein said second designated metal ion comprises Fe.

33. The method according to claim 28 wherein said container comprises a bottle and cap assembly.

34. The method according to claim 33 wherein said bottle is made of a plastic material.

35. The method according to claim 33 wherein said second metal-ion sequestering agent is provided on the internal surface of said bottle.

36. The method according to claim 33 wherein said bottle is made of a material that includes said second metal-ion sequestering.

37. The method according to claim 33 wherein said second metal-ion sequestering agent is provided on the internal surface of said cap.

38. The method according to claim 28 wherein said liquid has a pH equal to or greater than about 3.

39. A method according to claim 28 wherein said first and/or second metal ion sequestering agents include an antimicrobial agent.

40. The method according to claim 39 wherein said antimicrobial agent comprises an antimicrobial active material selected from benzoic acid, sorbic acid, nisin, thymol, allicin, peroxides, imazalil, triclosan, benomyl, metal-ion release agents, metal colloids, anhydrides, and organic quaternary ammonium salts, a metal ion exchange reagents such as silver sodium zirconium phosphate, silver zeolite, or silver ion exchange resin.

41. The method according to claim 28 wherein said second metal-ion sequestering agent is immobilized on the surface(s) of said container and has a stability constant greater than 10¹⁰ with iron (III).

42. The method according to claim 28 wherein said second metal ion sequestering agent is immobilized on the surface(s) of said container and has a high-affinity for biologically important metal-ions such as Mn, Zn, Cu and Fe.

43. The method according to claim 28 wherein said first or second sequestering agent has a high-selectively for certain metal-ions but a low-affinity for at least one other ion.

44. The method according to claim 28 wherein said first or second metal-ion sequestering agent is immobilized on the surface(s) of said container and has a stability constant greater than 10¹⁰ with iron (III) and said antimicrobial agent comprises an antimicrobial active material selected from benzoic acid, sorbic acid, nisin, thymol, allicin, peroxides, imazalil, triclosan, benomyl, metal-ion release agents, metal colloids, anhydrides, and organic quaternary ammonium salts.

45. The method according to claim 28 wherein said first or second metal-ion sequestering agent is immobilized on the surface(s) of said container and has a stability constant greater than 10²⁰ with iron (III).

46. The method according to claim 28 wherein said first or second metal-ion sequestering agent is immobilized on the surface(s) of said container and has a stability constant greater than 10¹⁰ with iron (III) and said antimicrobial agent comprises a metal ion selected from one of the following:
silver;
copper;
gold;
nickel;
tin;
zinc.

47. The method according to claim 28 wherein said first or second metal-ion sequestering agent comprises derivatized nanoparticles comprising inorganic nanoparticles having an attached metal-ion sequestrant, wherein said inorganic nanoparticles have an average particle size of less than 200 nm and the derivatized nanoparticles have a stability constant greater than 10¹⁰ with iron (III).

48. The method according to claim 28 wherein said subjecting said liquid to said first metal-ion sequestering agent occurs in an ion bed exchange device.

49. The method according to claim 28 wherein said subjecting said liquid to said first metal-ion sequestering agent occurs in a filter device.
